(19) United States
(12) Patent Application Publication
(10) Pub. No.: US 2014/0337081 A1
(43) Pub. Date: Nov. 13, 2014

(54) METHODS AND SYSTEMS FOR PERFORMING CAPACITY MANAGEMENT IN A PRINT PRODUCTION ENVIRONMENT

(71) Applicant: XEROX CORPORATION, Norwalk, CT (US)

(72) Inventors: Bo Hu, Pittsford, NY (US); Faming Li, Solon, OH (US)

(73) Assignee: Xerox Corporation, Norwalk, CT (US)

(21) Appl. No.: 13/888,668

(22) Filed: May 7, 2013

(51) Int. Cl. G06Q 10/06

(52) U.S. Cl. CPC G06Q 10/06315
USPC 705/7.25

(57) ABSTRACT

A method of adjusting labor capacity in a print production environment may include receiving, by a computing device, a realized demand value for a print production environment and determining that the realized demand value exceeds a total labor capacity associated with one or more workers in the print production environment. The method may include, in response to determining that the realized demand value exceeds the total labor capacity associated with the print production environment, determining one or more updated compensation rates for the one or more workers, determining one or more production parameters corresponding to each of the updated compensation rates, presenting the determined updated compensation rates and corresponding production parameters to a user, receiving a selection of an updated compensation rate from the presented compensation rates, and communicating the selected updated compensation rate to the one or more workers.

### BACKGROUND

In the service industry, it is a continuous challenge to match labor capacity with uncertain future demand. Some service providers choose to use workforce management tools to help make staffing decisions. Workforce management tools often utilize a demand forecast algorithm to predict demand and make a staffing recommendation. However, there is an inherent uncertainty in forecasting future demand, which makes it difficult to accurately predict labor capacity.

In addition, workforce management tools typically assume that the labor capacity of each worker is fixed. Because of potential penalties that might be incurred if certain service levels are not met, service providers try their best to match labor capacity with demand. For example, they may hire enough workers to cover forecasted peak demand and reduce some workers' hours during low demand periods.

### SUMMARY

This disclosure is not limited to the particular systems, methodologies or protocols described, as these may vary. The terminology used in this description is for the purpose of describing the particular versions or embodiments only, and is not intended to limit the scope.

As used in this document, the singular forms “a,” “an,” and “the” include plural reference unless the context clearly dictates otherwise. Unless defined otherwise, all technical and scientific terms used herein have the same meanings as commonly understood by one of ordinary skill in the art. All publications mentioned in this document are incorporated by reference. All sizes recited in this document are by way of example only, and the invention is not limited to structures having the specific sizes or dimension recited below. As used herein, the term “comprising” means “including, but not limited to.”

In an embodiment, a method of adjusting labor capacity in a print production environment may include receiving, by a computing device, a realized demand value for a print production environment and determining that the realized demand value exceeds a total labor capacity associated with one or more workers in the print production environment. The method may include, in response to determining that the realized demand value exceeds the total labor capacity associated with the print production environment, determining one or more updated compensation rates for the one or more workers, determining one or more production parameters corresponding to each of the updated compensation rates, presenting the determined updated compensation rates and corresponding production parameters to a user, receiving a selection of an updated compensation rate from the presented compensation rates, and communicating the selected updated compensation rate to the one or more workers. Each of the updated compensation rates may exceed a current compensation rate for the one or more workers.

In an embodiment, a system of adjusting labor capacity in a production environment may include a computing device and a computer-readable storage medium in communication with the computing device. The computer-readable storage medium may include one or more programming instructions that, when executed, cause the computing device to receive a realized demand value for a production environment and determine that the realized demand value exceeds the total labor capacity associated with one or more workers in the production environment. The computer-readable storage medium may include one or more programming instructions that, when executed, cause the computing device to in response to determining that the realized demand value exceeds a total labor capacity associated with a production environment, determine one or more updated compensation rates for the one or more workers, determine one or more production parameters corresponding to each of the updated compensation rates, present the determined updated compensation rates and corresponding production parameters to a user, receive a selection of an updated compensation rate from the presented compensation rates, and communicate the selected updated compensation rate to the one or more workers. Each of the updated compensation rates may exceed a current compensation rate for the one or more workers.

In an embodiment, a method of adjusting labor capacity in a production environment may include receiving, by a computing device, a realized demand value for a production environment, determining that the realized demand value does not exceed a total labor capacity associated with one or more workers in the production environment, in response to determining that the realized demand value does not exceed the total labor capacity associated with the production environment, determining one or more updated compensation rates for the one or more workers, determining one or more production parameters corresponding to each of the updated compensation rates, presenting the determined updated compensation rates and corresponding production parameters to a user, receiving a selection of an updated compensation rate from the presented compensation rates, and communicating the selected updated compensation rate to the one or more workers. Each of the updated compensation rates may exceed a current compensation rate for the one or more workers.

### BRIEF DESCRIPTION OF THE DRAWINGS

FIG. 1 illustrates a block diagram of an example workforce management tool according to an embodiment.

FIG. 2 illustrates an example method of determining a recommended staffing level for a production environment according to an embodiment.

FIG. 3 illustrates a block diagram of an example workforce management tool and capacity management tool according to an embodiment.

FIG. 4 illustrates a flow chart of an example method of determining a compensation rate for one or more workers according to an embodiment.

FIGS. 5 and 6 illustrate example graphs according to various embodiments.

FIG. 7 illustrates a block diagram of example hardware that may be used to contain or implement program instructions according to an embodiment.

### DETAILED DESCRIPTION

The following terms shall have, for purposes of this application, the respective meanings set forth below:

A “computing device” refers to a device that includes a processor and tangible, computer-readable memory. The memory may contain programming instructions that, when executed by the processor, cause the computing device to perform one or more operations according to the programming instructions. Examples of computing devices include personal computers, servers, mainframes, gaming systems, televisions, and portable electronic devices such as smartphones, personal digital assistants, cameras, tablet computers, laptop computers, media players and the like.

A “job” refers to a logical unit of work that is to be completed for a customer. For example, in a print production environment, a job may include one or more print jobs from one or more clients. For example, a job in a vehicle production environment may include manufacturing a vehicle or a portion thereof. As another example, a job in a chemical production environment may include producing or processing a chemical product or a portion thereof. Similarly, a job in a computing device production environment may be to manufacture a computing device or a portion thereof such as, for example, a printer, a scanner or a copier.

“Labor capacity” refers to a rate at which a worker completes one or more jobs during a time period. For instance, ten jobs per hour may be an example labor capacity of a worker according to an embodiment.

A “labor cost” refers to a financial cost paid to a worker for services over a period of time. A labor cost may include salary, wages or other payment or compensation.

A “module” refers to a component of a larger system. In an embodiment, a module may include hardware, software or a combination of hardware and software.

An “operational profit” refers to a financial amount over a period of time that is represented by the difference between revenue and labor cost.

A “print job” refers to a job processed in a print shop. For example, a print job may include a series of processing steps for producing credit card statements corresponding to a certain credit card company, producing bank statements corresponding to a certain bank, printing a document, or the like. In this document, a print job may refer to the set of instructions that cause the items to be produced or printed, as well as the work-in-progress and produced items themselves.

A “production environment” refers to machine and/or human labor used to complete one or more jobs. A production environment may include one or more personnel, devices or equipment that may be used to complete one or more jobs. Example production environments may include, without limitation, a print production environment, a chemical production environment, a vehicle production environment, a computing device manufacturing production environment, and/or other manufacturing production environments.

A “realized demand value” refers to a value of a job demand in a production environment at a particular time.

“Revenue” refers to a financial amount generated by a worker on behalf of an employer or contracting party over a period of time.

The labor capacity of a worker may vary with the amount of compensation provided to the worker. For example, in a service environment, worker compensation may be related to the amount of work a worker successfully completes during a period of time. The labor capacity at which a worker is willing to work may increase if the worker is monetarily or otherwise incentivized.

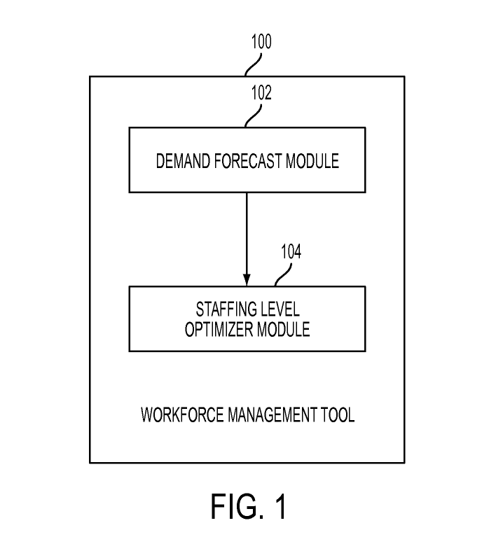

In an embodiment, a workforce management (WFM) tool may be used to determine a recommended staffing level for a production environment. FIG. 1 illustrates a block diagram of an example WFM tool according to an embodiment. As illustrated by FIG. 1, a WFM tool 100 may include a demand forecast module 102 and a staffing level optimizer module 104. A demand forecast module 102 may analyze information to provide an estimate of future demand over a period of time for a production environment. A staffing level optimizer module 104 may be in communication with the demand forecast module 102 and may provide one or more recommendations on staffing levels based on the output of the demand forecast module.

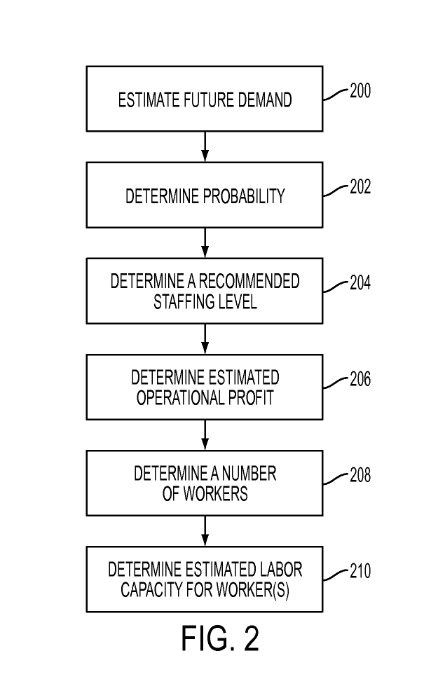

FIG. 2 illustrates an example method of determining a recommended staffing level for a production environment according to an embodiment. As illustrated by FIG. 2, future demand may be estimated 200. In an embodiment, future demand may be estimated 200 based on historical demand information. Historical demand information may include demand data associated with a production environment over a past period of time.

In an embodiment, a probability associated with an estimated future demand value may be determined 202. A probability may indicate a strength or weight associated with the future demand value.

For example, a demand forecast module may analyze at least a portion of historical demand information for a production environment, and it may make the estimations of future demand for the production environment that are illustrated in Table 1.

TABLE 1

| Estimated demand (jobs/hour) | Probability |
|---|---|
| 10 | 0.40 |
| 20 | 0.30 |
| 30 | 0.30 |

As illustrated by Table 1, a demand forecast module may estimate that, with a probability of 0.4, the future demand of work is 10 jobs per hour. The demand forecast module may estimate that, with a probability of 0.3, the future demand of work is 20 jobs per hour. The demand forecast module may estimate that, with a probability of 0.30, the future demand of work is 30 jobs per hour.

In an embodiment, a recommended staffing level for a production environment may be determined 204. A recommended staffing level may be determined 204 based on the estimated future demand information. In an embodiment, a recommended staffing level may be determined 204 based on revenue information and/or cost information associated with a production environment. Revenue information may include revenue generated by one or more workers, labor costs associated with one or more workers and/or the like.

In an embodiment, a recommended staffing level may be determined 204 by determining 206 an estimated operational profit for a first hired worker and one or more subsequently hired workers. A first hired worker may have the highest probability of having a supply of jobs to complete, and therefore may have the highest likelihood of generating revenue and incurring labor costs. With each subsequently hired worker, the probability that the subsequent worker will have jobs to complete decreases.

In an embodiment, an estimated operational profit may be determined for one or more workers for one or more estimated future demand values. Table 2 illustrates example operational profit associated with three workers for each of the estimated demand values illustrated in Table 1. In this example, the following assumptions may apply. Revenue generated by each job is $3.00/job. A worker's compensation is a combination of a base wage, such as, for example, minimum wage, and an amount equal to a fixed job rate times the number of jobs completed. For example, a base wage may be $10/hour and the job rate may be $1.00 for each completed job. In an embodiment, base wage may be a sunk cost once a worker is hired because the employer has to pay the worker the base wage even if there are no jobs to complete. The job rate compensation may be incentive-based as a worker only gets paid for the number of jobs that he or she completes. All other operational costs may be normalized to zero. At a job rate of $1.00/job, an average employee may be willing to work at a labor capacity of 10 jobs/hour. Therefore, if the worker works at full capacity, the work will generate a revenue stream of $30/hour and incurs a labor cost of $20/hour. As such, the operational profit is $10/hour. If a worker has no jobs to complete, the revenue stream is zero while the labor cost is $10/hour. As a result, the employer bears a net operational loss of $10/hour.

TABLE 2

| | Estimated | | Will worker | | Labor | Estimated |
|---|---|---|---|---|---|---|
| | demand | | actually | Revenue | cost | profit/loss |
| Workers | (jobs/hour) | Probability | work? | ($/hour) | ($/hour) | ($/hour) |
| 1st | 10 | 0.40 | Y | 30 | 20 | 0.4 * (30 − 20) + |
| | 20 | 0.30 | Y | 30 | 20 | 0.6 * (30 − 20) = |
| | 30 | 0.30 | Y | 30 | 20 | 10 |
| 2^{nd} | 10 | 0.40 | N | 0 | 10 | 0.4 * (0 − 10) + |
| | 20 | 0.30 | Y | 30 | 20 | 0.3 * (30 − 20) + |
| | 30 | 0.30 | Y | 30 | 20 | 0.3 (30 − 20) = 2 |
| 3^{rd} | 10 | 0.40 | N | 0 | 10 | 0.4* (0 − 10) + |
| | 20 | 0.30 | N | 0 | 10 | 0.3* (0 − 10) + |
| | 30 | 0.30 | Y | 30 | 20 | 0.3 * (30 − 20) = −4 |

As illustrated by Table 2, the probability of the future demand at 10 jobs per hour or higher is 1. Therefore, a first worker who is hired may work at a capacity of 10 jobs per hour with a probability of 1 and may generate a revenue stream of $30 per hour and incur a labor cost of $20 per hour. As such, the estimated operational profit associated with hiring the first worker is $10 per hour.

The probability of the future demand at 20 jobs per hour or higher may be 0.6. Therefore, a second worker that is hired may work at a capacity of 10 jobs per hour with a probability of 0.6. The second worker may generate a revenue stream of $30 per hour and a labor cost of $20 per hour.

With a probability of 0.4, the second worker may be without jobs at which to work, and thus may generate zero revenue and incur a labor cost of $10 per hour. Therefore, the estimated operational profit of hiring the second worker is $2 per hour. The probability of the future demand at 30 jobs per hour may be 0.3. Therefore, a third worker may work at a capacity of 10 jobs per hour with a probability of 0.3. The third worker may generate a revenue stream of $30 per hour and a labor cost of $20 per hour. However, there is a higher probability (0.7) that the third worker will be without jobs at which to work, and thus may generate zero revenue and incur a labor cost of $10 per hour. Therefore, the estimated operational profit of hiring the third worker may be −$4 per hour.

In an embodiment, a number of workers that maximizes estimated operational profit may be determined 208, and this number may be the recommended staffing level for a production environment. In an embodiment, an estimated labor capacity associated with each determined worker may be determined 210. For instance, referring to the above example and Table 2, the recommended staffing level for the production environment may be two workers. If demand realizes at 20 jobs/hour or more, each of the two workers may work at a labor capacity of 10 jobs per hour. Table 3 illustrates example information associated with the two workers in this situation according to an embodiment. If demand realizes at 10 jobs/hour, a first worker may bring in a revenue stream of $30/hour and incurring a labor cost of $20/hour. The second worker may not generate revenue, but may incur a labor cost of $10/hour. In such a situation, the operational profit may be $0.

TABLE 3

| | Labor Capacity | Revenue | Labor Cost | Operational |
|---|---|---|---|---|
| Worker | (jobs/hour) | ($/hour) | ($/hour) | Profit ($/hour) |
| Worker 1 | 10 | 30 | 20 | 10 |
| Worker 2 | 10 | 30 | 20 | 10 |
| Total | 20 | 60 | 40 | 20 |

In an embodiment, a capacity management tool (CMT) may be used to recommend a compensation for one or more workers. A CMT may be implemented in hardware, software or a combination of hardware and software. In an embodiment, a CMT may adjust labor capacity in real time to match demand by increasing or decreasing compensation rate.

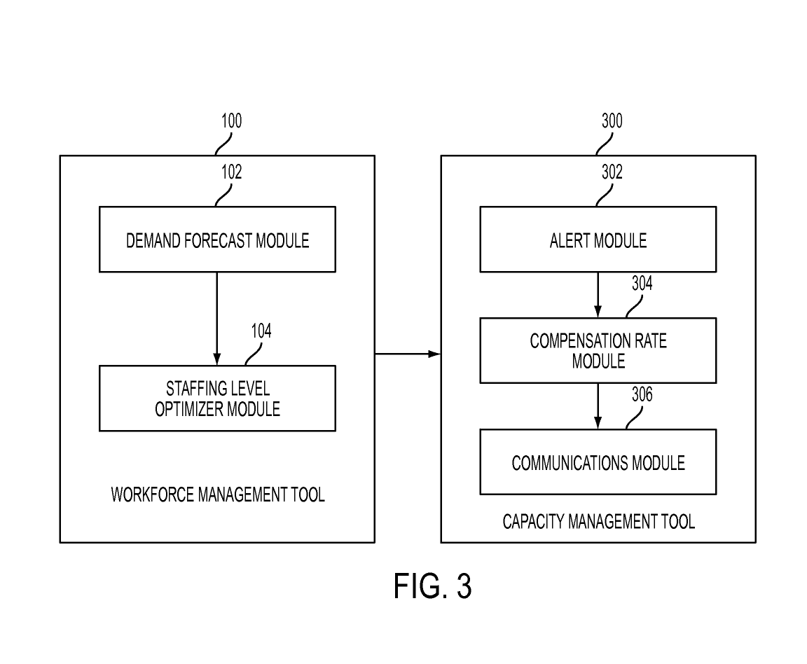

As illustrated by FIG. 3, a CMT 300 may be in communication with a WFM tool 100. The WFM tool 100 may send the CMT 300 the recommended staffing level, revenue information associated with one or more workers of the recommended staffing level and/or labor capacity associated with one or more workers of the recommended staffing level. For example, referring to the above example, the WFM 100 may send to the CMT 300 an indication that a staffing level of two workers is recommended, that, in the event that demand realized is 20 jobs/hour or more, the operational profit is $20/hour, that, in the event that the demand realized is 10 jobs/hour, the operational profit is $0/hour, and/or the like.

As illustrated by FIG. 3, a CMT 300 may include an alert module 302. An alert module 302 may generate one or more alerts or notifications of a capacity shortage or capacity excess. A CMT 300 may include a compensation rate optimizer module 304. A compensation rate optimizer module 304 may determine one or more temporary compensation rates for one or more workers. A CMT 300 may include a communication module 306 which may communicate one or more compensation rates to one or more workers.

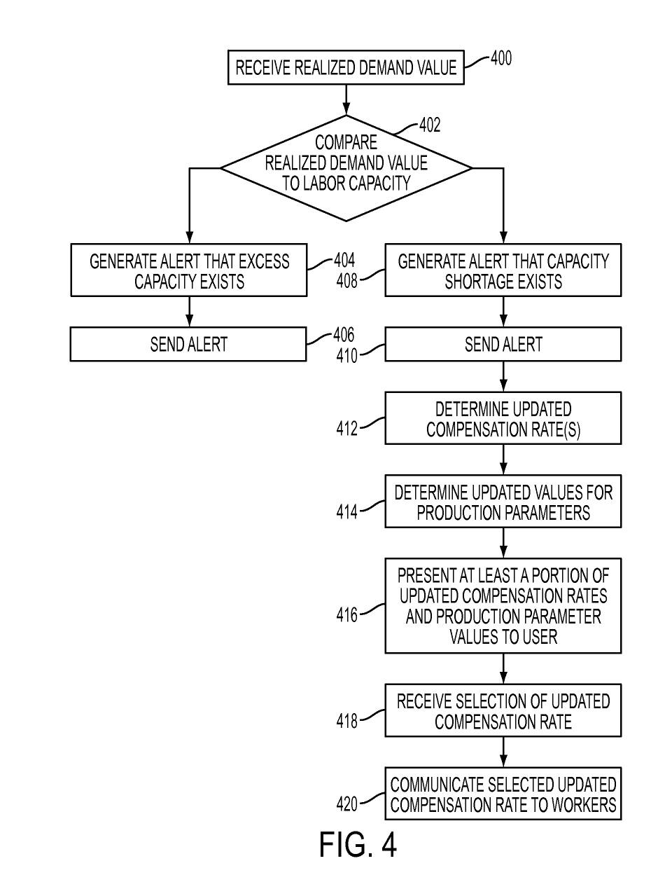

FIG. 4 illustrates a flow chart of an example method of determining a compensation rate for one or more workers according to an embodiment. As illustrated by FIG. 4, a realized demand value may be received 400 by a CMT. A realized demand value may be an actual demand value associated with a production environment over a period of time. A realized demand value may be received by a CMT from a computing device, such as, for example, a computing device that receives one or more jobs.

In an embodiment, the CMT may compare 402 the realized demand value to the labor capacity of the workers in the production environment. If the realized demand value is less than the labor capacity of the workers, the alert module of the CMT may generate 404 and send 406 an alert that excess capacity exists. If the realized demand value exceeds the labor capacity of the workers, the alert module of the CMT may generate 408 and send 410 an alert that a capacity shortage exists.

In an embodiment, one or more updated compensation rates may be determined 412 for one or more workers. In an embodiment, an updated compensation rate may be determined 412 for one or more workers in response to determining that a labor capacity shortage exists. For example, a realized demand value that exceeds the labor capacity may be received. Because a portion of the realized demand will not be completed with the current labor capacity, the CMT may determine 412 one or more increased compensation rates that may incentivize the workers to adjust their labor capacity. In an embodiment, the CMT may determine 414 updated values of one or more production parameters based on an increased compensation rate. For example, a CMT may determine an update labor capacity, revenue, labor cost and/or operation profit values for one or more increased compensation rates.

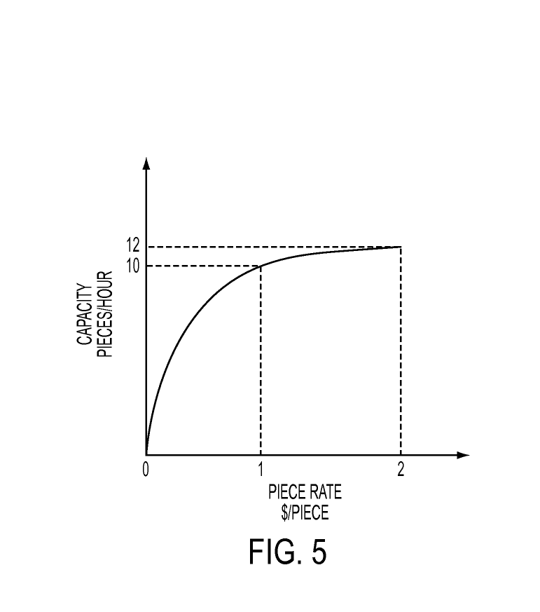

FIG. 5 illustrates a graph of marginal compensation rate vs. labor capacity according to an embodiment. As illustrated by FIG. 5, the relation shows an upward concavity. In an embodiment, an optimal compensation rate may be determined by considering one or more factors such as, for example, an industrial average compensation, operational cost, and or the like. FIG. 5 illustrates an optimal compensation rate of $1/job which should result in a worker producing approximately 10 jobs per hour. As such, the two workers of the above example may be paid $1 for each job they complete. A realized demand value of 30 jobs per hour may be determined. Because the realized demand value exceeds the labor capacity of the workers (i.e., collectively, 20 jobs per hour), a capacity shortage may exist and one or more updated compensation rates may be determined 412.

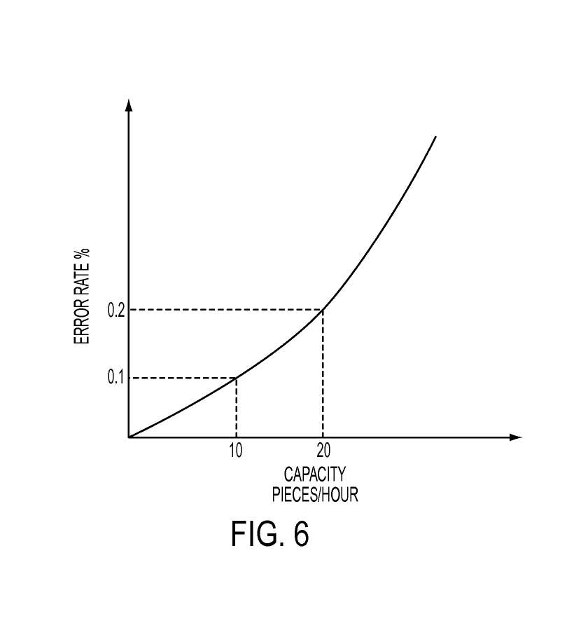

In an embodiment, offering updated compensation rates may serve as an incentive for workers to adjust their labor capacity, such as by increasing their labor capacity. However, as labor capacity increases, quality may decrease. For example, a worker who increases his or her yield may sacrifice quality of the jobs produced in order to meet a heightened capacity. As such, an error rate associated with production may increase as labor capacity increases. FIG. 6 illustrates a graph showing labor capacity as a function of error rate. As illustrated by FIG. 6, as labor capacity increases, so does error rate.

In an embodiment, an updated compensation rate that maximizes expected profit without exceeding a certain error rate may be determined 412. In an embodiment, a user may identify a threshold value associated with an error rate. For example, a user may identify a maximum value associated with an error rate. As illustrated by FIG. 6, a threshold value associated with error rate may be 0.2%. As such, the maximum possible labor capacity that is achievable may be 20 jobs per hour as illustrated by FIG. 6.

In an embodiment, the compensation rate optimizer may determine 412 an updated compensation rate based on expected profit, error rate and/or labor capacity projections. In an embodiment, a labor capacity value associated with a current compensation rate may be determined, and an error rate threshold value may be determined. A labor capacity value that is associated with the error rate threshold value may be determined. One or more updated compensation rates may be determined. In an embodiment, one or more updated compensation rates may be determined that are each associated with a labor capacity that exceeds the labor capacity value associated with a current compensation and that does not exceed the labor capacity value that is associated with the error rate threshold value.

For instance, referring to the above example, a current compensation rate may be equal to $1 per job. An error rate threshold value may be 0.2% which may correspond to a labor capacity value of 20 jobs per hour. One or more updated compensation rates may be determined that are each associated with a labor capacity value that is between 10 jobs per hour and 20 jobs per hour. For example, an updated marginal compensation rate of $2 per job may be determined. For example, workers may be paid $1/job for the first ten completed jobs, and $2/job for any jobs in excess of ten. The increased marginal compensation rate of $2 per job may correspond to a labor capacity of 12 jobs per hour, which may correspond to an error rate that is less than the threshold value of 0.2%

One or more updated production parameters may be determined for the determined compensation rate. For example, the system may determine that, due to the increase in compensation rate, the workers can improve their efficiency and complete 12 jobs per hour. As such, the two workers can work at a total labor capacity of 24 jobs per hour. The operation will generate a revenue stream of $72 per hour and incur a labor cost of $48 per hour. As such, the operational profit may be $24 per hour, which may be higher than the operational profit of $20 per hour when the CMT is not used.

In an embodiment, at least a portion of the determined compensation rates and production parameters may be presented 416 to one or more users. For example, determined compensation rates and corresponding production parameters may be presented 416 to a manager according to an embodiment. In an embodiment, the determined compensation rates and corresponding production parameters may be emailed, displayed and/or otherwise presented 416 to a user.

In an embodiment, a selection of a presented compensation rate may be received 418. The selected compensation rate may be communicated 420 to one or more workers. For example, a selected compensation rate may be communicated with one or more workers via a communication module of a CMT. The communication module may email or otherwise communicate a selected compensation rate to one or more workers.

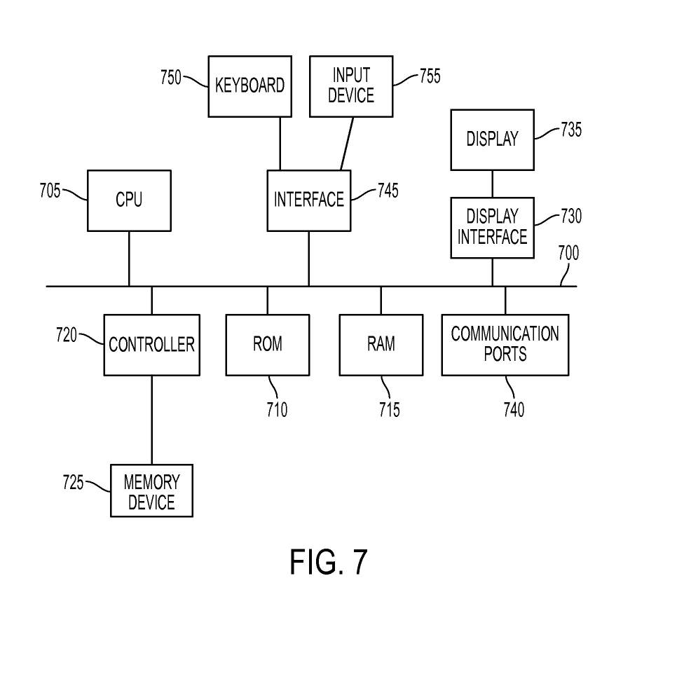

FIG. 7 depicts a block diagram of hardware that may be used to contain or implement program instructions. A bus 700 serves as the main information highway interconnecting the other illustrated components of the hardware. CPU 705 is the central processing unit of the system, performing calculations and logic operations required to execute a program. CPU 705, alone or in conjunction with one or more of the other elements disclosed in FIG. 7, is an example of a production device, computing device or processor as such terms are used within this disclosure. Read only memory (ROM) 710 and random access memory (RAM) 715 constitute examples of non-transitory computer-readable storage media.

A controller 720 interfaces with one or more optional non-transitory computer-readable storage media 725 to the system bus 700. These storage media 725 may include, for example, an external or internal DVD drive, a CD ROM drive, a hard drive, flash memory, a USB drive or the like. As indicated previously, these various drives and controllers are optional devices.

Program instructions, software or interactive modules for providing the interface and performing any querying or analysis associated with one or more data sets may be stored in the ROM 710 and/or the RAM 715. Optionally, the program instructions may be stored on a tangible non-transitory computer-readable medium such as a compact disk, a digital disk, flash memory, a memory card, a USB drive, an optical disc storage medium, such as a Blu-Ray™ disc, and/or other recording medium.

An optional display interface 730 may permit information from the bus 700 to be displayed on the display 735 in audio, visual, graphic or alphanumeric format. Communication with external devices, such as a printing device, may occur using various communication ports 740. A communication port 740 may be attached to a communications network, such as the Internet or an intranet.

The hardware may also include an interface 745 which allows for receipt of data from input devices such as a keyboard 750 or other input device 755 such as a mouse, a joystick, a touch screen, a remote control, a pointing device, a video input device and/or an audio input device.

It will be appreciated that various of the above-disclosed and other features and functions, or alternatives thereof, may be desirably combined into many other different systems or applications or combinations of systems and applications. Also that various presently unforeseen or unanticipated alternatives, modifications, variations or improvements therein may be subsequently made by those skilled in the art which are also intended to be encompassed by the following claims.

What is claimed is:

1. A method of adjusting labor capacity in a print production environment, the method comprising:
receiving, by a computing device, a realized demand value for a print production environment;
determining that the realized demand value exceeds a total labor capacity associated with one or more workers in the print production environment;
in response to determining that the realized demand value exceeds the total labor capacity associated with the print production environment:
determining one or more updated compensation rates for the one or more workers, wherein each of the updated compensation rates exceeds a current compensation rate for the one or more workers,
determining one or more production parameters corresponding to each of the updated compensation rates,
presenting the determined updated compensation rates and corresponding production parameters to a user,
receiving a selection of an updated compensation rate from the presented compensation rates, and
communicating the selected updated compensation rate to the one or more workers.

2. The method of claim 1, wherein determining one or more updated compensation rates comprises:
determining a first labor capacity value associated with the current compensation rate;
determining an error rate threshold value;
determining a second labor capacity value associated with the error rate threshold value;
identifying one or more updated compensation rates that are each associated with a labor capacity value that exceeds the first labor capacity value and does not exceed the second labor capacity value.

3. The method of claim 2, wherein identifying one or more updated compensations rates comprises identifying one or more updated compensation rates that maximize an expected profit value for the print production environment.

4. The method of claim 1, wherein determining one or more updated compensation rates comprises identifying one or more updated compensation rates that each maximizes an expected profit value for the print production environment and that is associated with a labor capacity value that corresponds to an error rate value that does not exceed the error rate threshold value.

5. The method of claim 1, wherein determining one or more production parameters corresponding to the updated compensation rate comprises determining one or more of the following:
an expected profit value for the print production environment;
an error rate value; and
a labor capacity value.

6. The method of claim 1, wherein presenting the determined updated compensation rates and corresponding production parameters to a user comprises displaying the determined updated compensation rates and corresponding production parameters on a display device.

7. The method of claim 1, wherein communicating the selected updated compensation rate to the one or more workers comprises causing the selected updated compensation rate to be displayed on a display device.

8. A system of adjusting labor capacity in a production environment, the system comprising:
a computing device; and
a computer-readable storage medium in communication with the computing device, wherein the computer-readable storage medium comprises one or more programming instructions that, when executed, cause the computing device to:
receive a realized demand value for a production environment,
determine that the realized demand value exceeds the total labor capacity associated with one or more workers in the production environment,
in response to determining that the realized demand value exceeds a total labor capacity associated with a production environment:
determine one or more updated compensation rates for the one or more workers, wherein each of the updated compensation rates exceed a current compensation rate for the one or more workers,
determine one or more production parameters corresponding to each of the updated compensation rates,
present the determined updated compensation rates and corresponding production parameters to a user,
receive a selection of an updated compensation rate from the presented compensation rates, and
communicate the selected updated compensation rate to the one or more workers.

9. The system of claim 8, wherein the one or more programming instructions that, when executed, cause the computing device to determine one or more updated compensation rates comprise one or more programming instructions that, when executed, cause the computing device to:
determine a first labor capacity value associated with the current compensation rate;
determine an error rate threshold value;
determine a second labor capacity value associated with the error rate threshold value; and
identify one or more updated compensation rates that are each associated with a labor capacity value that exceeds the first labor capacity value and does not exceed the second labor capacity value.

10. The system of claim 9, wherein the one or more programming instructions that, when executed, cause the computing device to identify one or more updated compensations rates comprise one or more programming instructions that, when executed, cause the computing device to identify one or more updated compensation rates that maximize an expected profit value for the production environment.

11. The system of claim 8, wherein the one or more programming instructions that, when executed, cause the computing device to determine one or more updated compensation rates comprise one or more programming instructions that, when executed, cause the computing device to identify one or more updated compensation rates that each maximizes an expected profit value for the production environment and that is associated with a labor capacity value that corresponds to an error rate value that does not exceed the error rate threshold value.

12. The system of claim 8, wherein the one or more programming instructions that, when executed, cause the computing device to determine one or more production parameters corresponding to the updated compensation rate comprise one or more programming instructions that, when executed, cause the computing device to determine one or more of the following:
an expected profit value for the production environment;
an error rate value; and
a labor capacity value.

13. The system of claim 8, wherein the one or more programming instructions that, when executed, cause the computing device to present the determined updated compensation rates and corresponding production parameters to a user comprise one or more programming instructions that, when executed, cause the computing device to display the determined updated compensation rates and corresponding production parameters on a display device.

14. The system of claim 8, wherein the one or more programming instructions that, when executed, cause the computing device to communicate the selected updated compensation rate to the one or more workers comprise one or more programming instructions that, when executed, cause the computing device to cause the selected updated compensation rate to be displayed on a display device.

15. A method of adjusting labor capacity in a production environment, the method comprising:
receiving, by a computing device, a realized demand value for a production environment;
determining that the realized demand value does not exceed a total labor capacity associated with one or more workers in the production environment;
in response to determining that the realized demand value does not exceed the total labor capacity associated with the production environment:
determining one or more updated compensation rates for the one or more workers, wherein each of the updated compensation rates exceeds a current compensation rate for the one or more workers,
determining one or more production parameters corresponding to each of the updated compensation rates,
presenting the determined updated compensation rates and corresponding production parameters to a user,
receiving a selection of an updated compensation rate from the presented compensation rates, and
communicating the selected updated compensation rate to the one or more workers.

16. The method of claim 15, wherein determining one or more updated compensation rates comprises:
determining a first labor capacity value associated with the current compensation rate;
determining an error rate threshold value;
determining a second labor capacity value associated with the error rate threshold value;
identifying one or more updated compensation rates that are each associated with a labor capacity value that does not exceed the first labor capacity value and exceeds the second labor capacity value.

17. The method of claim 16, wherein identifying one or more updated compensations rates comprises identifying one or more updated compensation rates that maximize an expected profit value for the production environment.

18. The method of claim 15, wherein determining one or more production parameters corresponding to the updated compensation rate comprises determining one or more of the following:
an expected profit value for the production environment;
an error rate value; and
a labor capacity value.

19. The method of claim 15, wherein presenting the determined updated compensation rates and corresponding production parameters to a user comprises displaying the determined updated compensation rates and corresponding production parameters on a display device.

20. The method of claim 1, wherein communicating the selected updated compensation rate to the one or more workers comprises causing the selected updated compensation rate to be displayed on a display device.
